(19) United States
(12) Patent Application Publication
(10) Pub. No.: US 2008/0100262 A1
(43) Pub. Date: May 1, 2008

(54) Mobile terminal device

(75) Inventors: Norio Ozaki, Kawasaki (JP); Takeshi Komuro, Kawasaki (JP); Masamichi Watanabe, Kawasaki (JP); Hiroshi Kubo, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/790,949

(22) Filed: Apr. 30, 2007

(30) Foreign Application Priority Data
Oct. 26, 2006 (JP) 2006-291661

(51) Int. Cl. H02J 7/00

(52) U.S. Cl. 320/112

(57) ABSTRACT

A battery housing frame includes a first side wall and a second side wall that hold a battery pack from both sides of the battery pack. The second side wall is elastic, and presses the battery pack towards the first side wall by contact pressure between one side of the battery pack housed in the battery housing.

### BACKGROUND OF THE INVENTION

1. Field of the Invention

The present invention relates to a mobile terminal device that includes a battery pack.

2. Description of the Related Art

Battery packs such as a lithium-ion battery pack have been used in mobile telephones. Generally, a battery pack used in a mobile telephone is housed in a battery housing inside the mobile telephone. Recently, mobile telephones have been multifunctional, and smaller and lighter. Because of the smaller size of mobile telephones, a space occupied by the battery housing tends to be reduced.

FIG. 8 is an exploded perspective view of a conventional mobile telephone P for explaining processes of housing a battery pack 20 in the conventional mobile telephone P. In FIG. 8, the mobile telephone P is viewed from the reverse side. FIG. 9 is a side view of the mobile telephone P for explaining processes of fitting the mobile telephone P in a battery housing frame 10a thereof.

As shown in FIGS. 8 and 9, the mobile telephone P includes a casing 1 (lower part in FIGS. 8 and 9) and a casing 2 (upper part in FIGS. 8 and 9), one on top of the other. The casing 2 is provided with the battery housing frame 10a that constitutes a battery housing 10 for housing the battery pack 20. An opening of the battery housing 10 is covered by a rear cover 3.

At two positions on a side wall 11 of the battery housing frame 10a (left side in FIG. 8 and right side in FIG. 9) are formed recesses 13 that engage with projections 21 at two positions on one side of the battery pack 20 (right side in FIG. 9). Substantially in the centre of the side wall 11 (FIG. 8) is a conductive terminal 15 that is connectable to a conductive terminal 23 of the battery pack 20 (FIG. 10).

On a side wall 12 of the battery housing frame 10a (right side in FIG. 8 and left side in FIG. 9) are circular recesses 14 that engage with circular projections 22 on another side of the battery pack 20.

On one part of the opening of the casing 2 is a slot 16 to attach the rear cover 3 to the casing 2. The slot 16 engages with a hook portion 4 on one edge of the rear cover 3 (right side in FIG. 8 and left side in FIG. 9).

With reference to FIG. 9, a procedure of housing the battery pack 20 is briefly explained. As shown in FIG. 9, first, the projections 21 of the battery pack 20 are fitted into the recesses 13 on the side wall 11 of the battery housing frame 10a.

At this stage, the other side of the battery pack 20 is fitted into the battery housing frame 10a, so that the projections 22 fit into the recesses 14 on the side wall 12 of the battery housing frame 10a. Next, the hook portion 4 of the rear cover 3 is fitted into the slot 16 formed at the periphery of the opening of the battery housing frame 10a (left side in FIG. 9), and another edge of the rear cover 3 (right side in FIG. 9) is fitted to the opening of the battery housing frame 10a. Thus, the battery pack 20 is housed and fitted to the battery housing frame 10a of the mobile telephone P.

A conventional technology for housing a battery pack in a battery housing is disclosed in, for example, Japanese Patent Application Laid-open No. 2000-36858. According to the conventional technology, the battery pack is fitted into the mobile telephone that includes a lock claw for fixing the battery pack and a lock releasing pin to release the lock on a hinge. The hinge extends from an edge of the battery pack of a mobile telephone.

In the conventional technology, because the lock releasing pin is provided on the hinge, a space for manipulating the lock releasing pin with a finger is not necessary, which simplifies fitting and removing of the battery pack from the battery housing. Consequently, it is possible to reduce the size of the mobile telephone.

Japanese Patent Application Laid-open No. H9-7570 discloses a mobile telephone that includes a battery cover that covers the opening of a battery housing (a battery pack housed inside). The battery cover is fixed with a lock plate that engages with a matching groove formed near the opening of the battery housing. When the lock plate fits into the matching groove, the battery housing is closed by the battery cover. The lock plate is formed integrally with the battery cover and is not a separate part, which reduces the number of parts and simplifies attachment of the battery cover to the battery housing.

Japanese Patent Application Laid-open No. H9-12047 discloses a cover of electronic equipment that is formed of two layers, namely, elastic and rigid resin layers. The elasticity of the cover reduces the noise arising between the cover and a cabinet.

However, with the conventional technologies, the function of holding the battery pack 20 inside the battery housing frame 10a of the battery housing 10 deteriorates due to repetitive use of the mobile telephone. The problem is explained with reference to FIG. 10. FIG. 10 is a schematic for explaining contact between the battery pack 20 and the conductive terminal 15 of the mobile telephone P.

As shown in FIG. 10, when the battery pack 20 is to be housed in the battery housing frame 10a, the projections 21 on the battery pack 20 fit in the recesses 13 on the side wall 11, and the projections 22 on the battery pack 20 fit in the recesses 14 on the side wall 12 (FIG. 9). Thus, the battery pack 20 is held in between the side wall 11 and the side wall 12.

When the battery pack 20 is housed in the battery housing frame 10a in such manner, the conductive terminal 23 of the battery pack 20 is pushed against the conductive terminal 15 on the side wall 11. The contact between the conductive terminal 15 and the conductive terminal 23 enables conduction (power supply) from the battery pack 20.

However, if the mobile telephone P is dropped or the battery pack 20 is changed frequently, there is a possibility of a slight rattling (a gap T) between a housing space of the battery housing frame 10a and the battery pack 20 housed inside the battery housing frame 10a.

The pressure between the conductive terminal 15 and the conductive terminal 23 is reduced due to the gap T. This creates variation in contact pressure between the conductive terminal 15 and the conductive terminal 23, which may result in loose connection.

With the conventional technologies described above, it is possible to reduce the size of the mobile telephone or to simplify the attachment of the cover. However, a problem of not being able to maintain stable contact between the conductive terminal of the mobile telephone and the conductive terminal of the battery pack, when the battery pack is housed in the battery housing, still remains.

### SUMMARY OF THE INVENTION

It is an object of the present invention to at least partially solve the problems in the conventional technology.

According to an aspect of the present invention, a mobile terminal device includes a battery housing that houses therein a battery pack, and includes a first side wall and a second side wall which hold the battery pack, and a cover that covers an opening of the battery housing. The first side wall includes a conductive terminal that abuts a power supply terminal on a first side of the battery pack housed in the battery housing. The second side wall presses the battery pack towards the first side wall by contact pressure between a second side of the battery pack in the battery housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a mobile telephone according to an embodiment of the present invention;

FIG. 2A is an enlarged side view of the mobile telephone;

FIG. 2B is an enlarged side view of the mobile telephone;

FIG. 3 is a side view of the mobile telephone before installation of a battery pack;

FIG. 4 is a side view of the mobile telephone during the installation of the battery pack;

FIG. 5 is a side view of the mobile telephone after the installation of the battery pack and attachment of a rear cover;

FIG. 6 is a side view of a side wall of the mobile telephone before the installation of the battery pack;

FIG. 7 is a side view of the side wall after the installation of the battery pack;

FIG. 8 is an exploded perspective view of a conventional mobile telephone for explaining processes of housing the battery pack therein;

FIG. 9 is a side view of the conventional mobile telephone for explaining the processes of housing the battery pack therein; and

FIG. 10 is a schematic for explaining contact between a conductive terminal of the battery pack and a conductive terminal of the mobile telephone.

### DETAILED DESCRIPTION OF THE PREFERRED EMBODIMENTS

Exemplary embodiments of the present invention are explained below in detail with reference to the accompanying drawings. The present invention is not limited to the embodiments explained below.

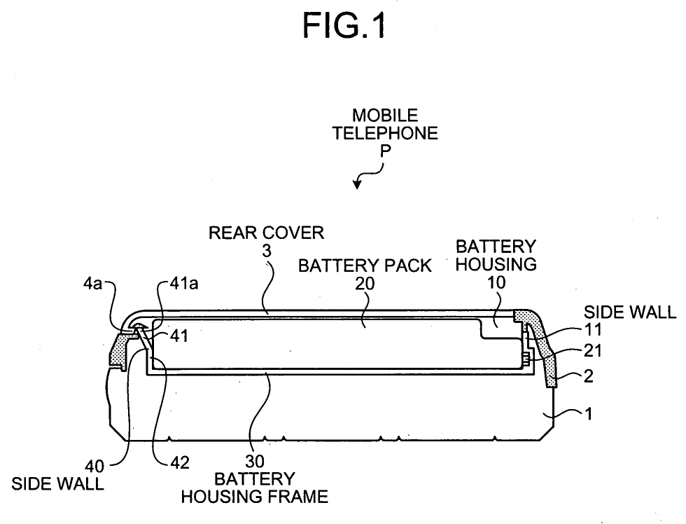

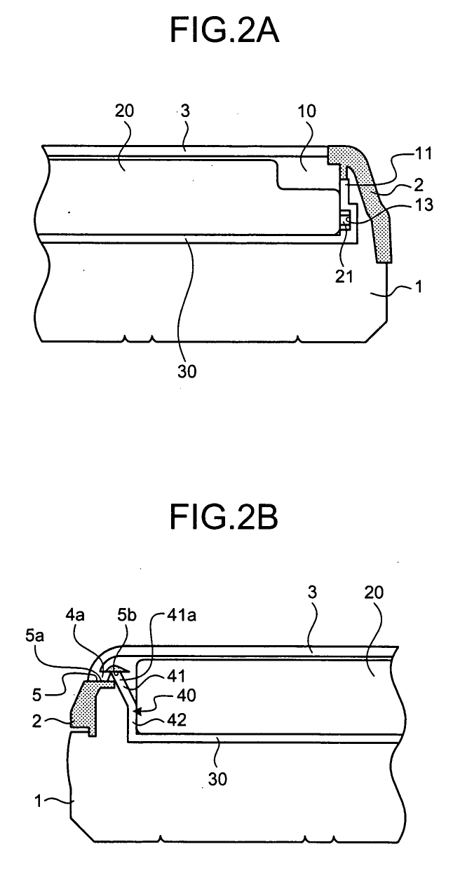

FIG. 1 is a side view of a mobile telephone according to an embodiment of the present invention. FIG. 2A is an enlarged side view of the right side of the mobile telephone. FIG. 2B is an enlarged side view of the left side of the mobile telephone.

A battery pack housing mechanism according to the embodiment differs from conventional one in the configuration of a side wall 40 that is one of a pair of side walls, a side wall 11 and the side wall 40, on two sides of a battery housing frame 30. Therefore, the configuration and effect of the side wall 40, i.e., the characteristic feature of the embodiment, is mainly explained. Detailed explanation regarding parts similar to conventional ones is omitted.

As shown in FIGS. 1, 2A, and 2B, a mobile telephone P includes a casing 1 (lower part in FIG. 1) and a casing 2 (upper part in FIG. 1). The casing 1 integrally includes various operating keys such as a numeric keypad (0 to 9) that is used for communication, function keys (mode setting keys), and a liquid crystal display (LCD). The casing 2 is located below the casing 1.

The casing 2 includes a battery housing 10 that houses therein a battery pack 20. The battery housing 10 includes the battery housing frame 30, which is approximately of the same size as the battery pack 20 (width), and is of rectangular shape. On the side wall 11, which forms a side of the battery housing frame 30 (right side in FIG. 1, right side in FIG. 2A) are two recesses 13 (only one shown in FIG. 2A) that fit with a pair of projections 21 (only one shown in FIG. 2A) on one side of the battery pack 20.

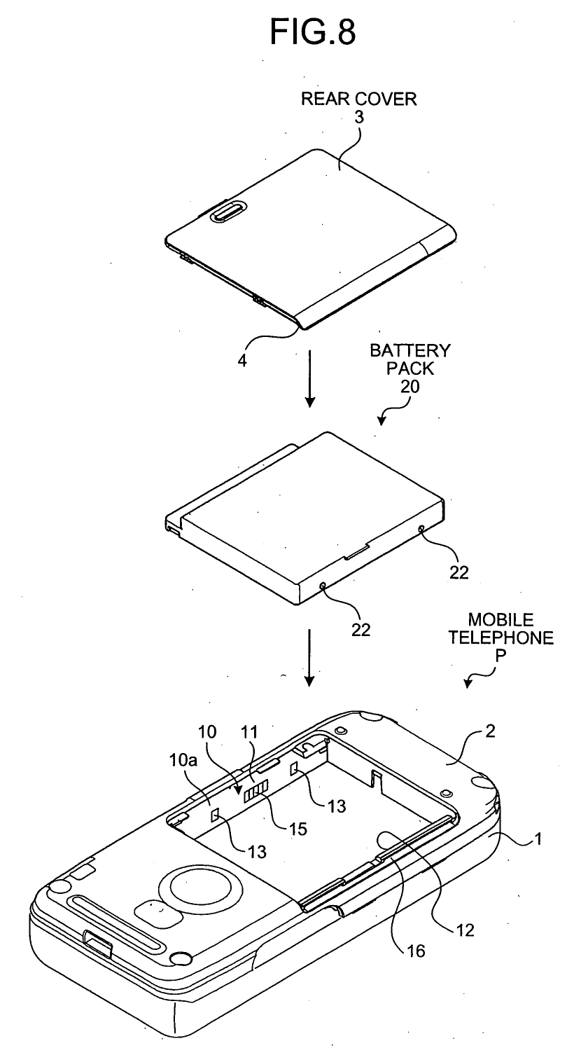

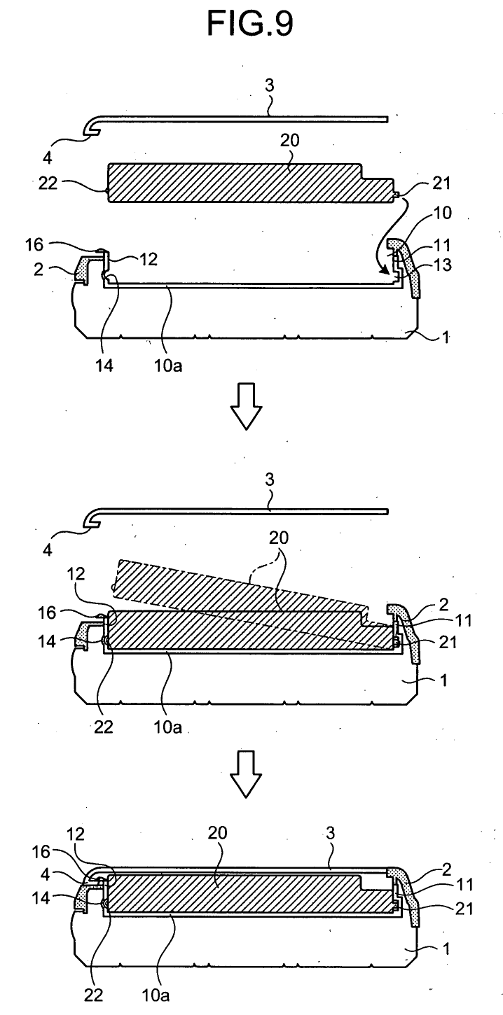

A conductive terminal 15 located substantially in the center of the side wall 11 (FIG. 8) is able to contact a conductive terminal 23 located substantially in the center of the battery pack 20. An opening of the battery housing 10 is covered by a rear cover 3 when the battery pack 20 is housed therein.

The specific feature of a housing mechanism of the battery pack 20 in the embodiment is that the side wall 40 is elastic. Specifically, out of a pair of the side walls 11 and 40, when the battery pack 20 is being fitted into the battery housing frame 30, the side wall 40 of the battery housing frame 30 provides elasticity to press the battery pack 20 towards the side wall 11.

A material used in the side wall 40 is an elastic resin, etc., and the side wall 40 is formed of a first side plate 41 and a second side plate 42, which give a bent form to the side wall 40.

When the battery pack 20 is being fitted into the battery housing frame 30, a circular projection 22 on the battery pack 20 slides downwards from the first side plate 41 along the second side plate 42 of the side wall 40. The battery pack 20 is pressed towards the side wall 11 due to the elasticity of the first side plate 41 and the second side plate 42.

The following is a detailed explanation regarding attachment of the rear cover 3 to the mobile telephone P with reference to FIG. 1 and FIG. 2B. At a periphery of the opening of the casing 2 (left side in FIG. 2B) is a slot 5 for attaching the rear cover 3 to the casing 2.

As shown in FIG. 2B, a horizontally long groove portion 5a and a holding member 5b, located on an opening side of the groove portion 5a (right side in FIG. 2B), are arranged in such a manner that the width of the slot 5 is substantially the same as the width of the rear cover 3. The groove portion 5a is formed to engage with a hook portion 4a on one edge of the rear cover 3 (right side in FIG. 2B).

When the battery pack 20 is housed in the battery housing frame 30, a tip portion 41a of the first side plate 41 abuts the holding member 5b on the slot 5. Thus, it is possible to reliably fix the first side plate 41 to a predetermined position with the help of the rear cover 3, and hold the battery pack 20 in a stable condition in between the side wall 11 and the side wall 40.

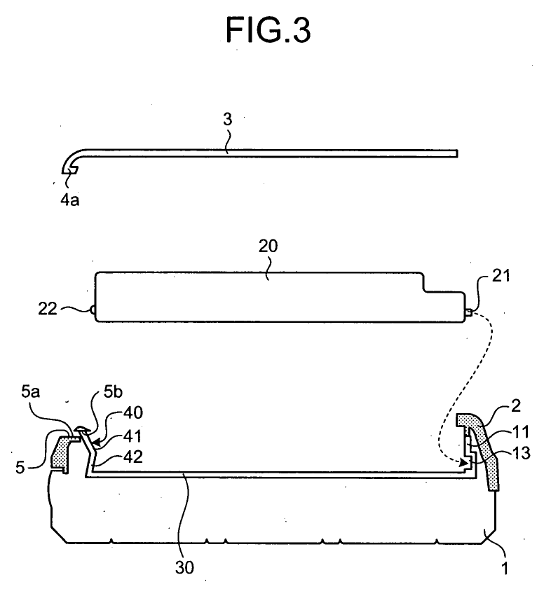

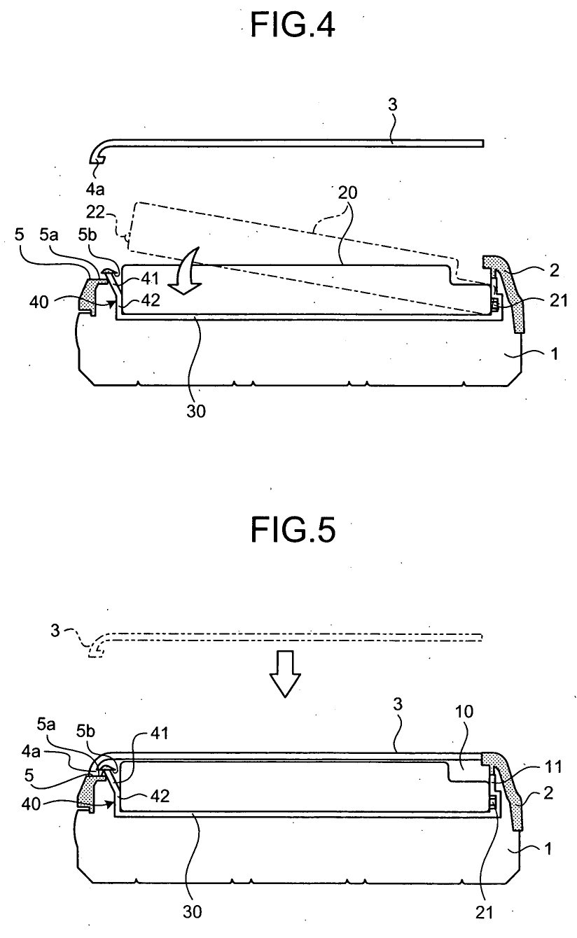

The processes of housing the battery pack 20 in the battery housing 10 are explained with reference to FIGS. 3 to 5. FIG. 3 is a side view of the mobile telephone before the installation of the battery pack 20. FIG. 4 is a side view of the mobile telephone during the installation of the battery pack 20. FIG. 5 is a side view of the mobile telephone after the installation of the battery pack 20 and attachment of the rear cover 3.

As shown in FIG. 3, first, the pair of projections 21 on one side of the battery pack 20 (right side in FIG. 3) is fitted into the recesses 13 on the side wall 11 of the battery housing frame 30.

Next, as shown in FIG. 4, another side of the battery pack 20 (left side in FIG. 4) is fitted into the battery housing frame 30 by pressing down the projection 22 from the first side plate 41 along the second side plate 42 of the side wall 40 (lower part in FIG. 4). Thus, the battery pack 20 is easily housed in between the side walls 11 and 40 of the battery housing frame 30.

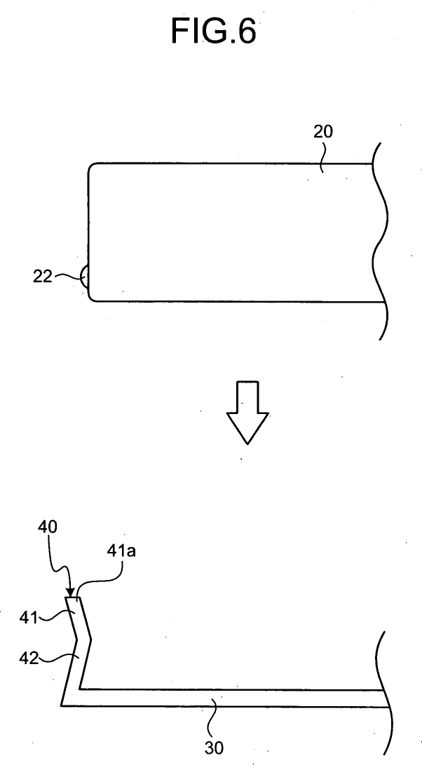

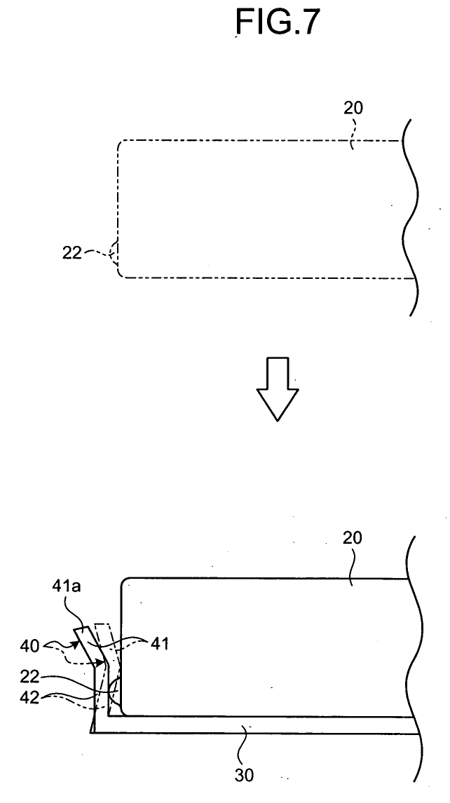

Details regarding the process of housing the battery pack 20 shown in FIG. 4 are explained with reference to FIGS. 6 and 7. FIG. 6 is a side view of the side wall 40 before the battery pack 20 is installed in the battery housing frame 30. FIG. 7 is a side view of the side wall 40 after the installation of the battery pack 20.

As shown in FIG. 6, the first side plate 41 and the second side plate 42 that form the side wall 40 can freely move until the battery pack 20 is installed in the battery housing frame 30. However, as shown in FIG. 7, at the time of housing the battery pack 20, when one side of the battery pack 20 (left side in FIG. 7) is pressed down along the first side plate 41 and the second side plate 42, the projection 22 on the battery pack 20 initially abuts the tip portion 41a of the first side plate 41 of the side wall 40. Then, the battery pack 20 reaches the position abutting the second side plate 42 while working against the elasticity of the first side plate 41. When further pressed downwards, the battery pack 20 is housed in the battery housing frame 30 while working against the elasticity of the second side plate 42.

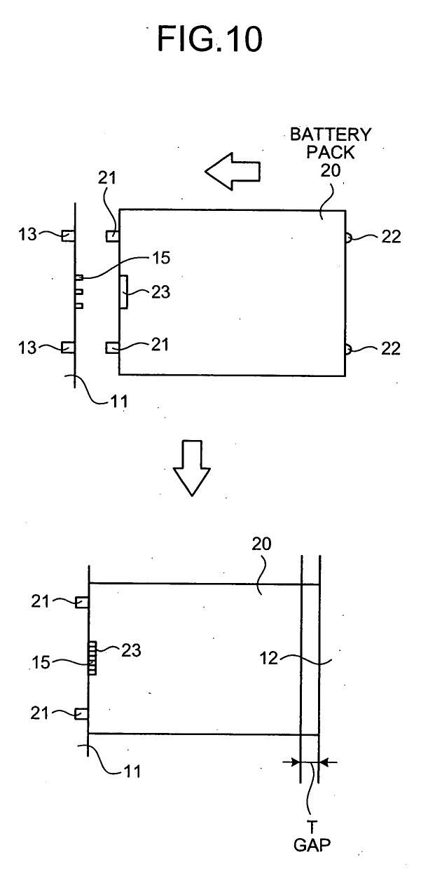

When the battery pack 20 is fitted in the battery housing frame 30, the battery pack 20 is pushed towards the side wall 11 (right side in FIG. 1) due to the elasticity of the first side plate 41 and the second side plate 42. Thus, the conductive terminal 23 on one side of the battery pack 20 (FIG. 10) comes in contact with the conductive terminal 15 (FIG. 8) on the side wall 11 with a predetermined pressure corresponding to the elasticity of the side wall 40.

When the battery pack 20 is completely housed in the battery housing frame 30 and abuts the second side plate 42, the second side plate 42 changes from a bent state to substantially upright state. This results in maintaining stable contact between the conductive terminal 15 of the mobile telephone P and the conductive terminal 23 of the battery pack 20, and preventing faults such as loose connection between the conductive terminal 15 and the conductive terminal 23.

As shown in FIG. 5, when installation of the battery pack 20 into the battery housing frame 30 is complete, the hook portion 4a on one end of the rear cover 3 (left side in FIG. 5) is engaged with the groove portion 5a of the slot 5, along with the engagement of the other end of the rear cover 3 with an edge of the opening of the battery housing frame 30 in the casing 2. Thus, the opening of the battery housing 10 is covered by the rear cover 3.

When the rear cover 3 is attached to the battery housing 10, the tip portion 41a of the side wall 40 abuts with the holding member 5b of the groove portion 5a. Thus, it is possible to reliably fix the side wall 40 in a predetermined position. According to the procedure explained above, it is also possible to fit and house the battery pack 20 in the battery housing 10 of the mobile telephone P.

As explained above, the mobile terminal device according to the embodiment includes the battery housing frame 30 that houses the battery pack 20, and the side wall 11 and the side wall 40. The two side walls 11 and 40 hold the battery pack 20 from both the sides. The side wall 40 is formed of the first side plate 41 and the second side plate 42, which have elasticity to press the battery pack 20 towards the side wall 11 with the contact pressure between the projection 22 on the battery pack 20. Thus, a stable contact can be maintained between the conductive terminal 15 of the mobile telephone P and the conductive terminal 23 of the battery pack 20.

Although the embodiment describes an application to the mobile telephone, it is possible to apply the present invention to other mobile terminals. For example, the present invention is applicable to battery housings in hingedly foldable mobile telephones, or mobile telephones that are configured of two casings overlapping one on top of the other, one sliding or in-plane rotating with respect to another.

In addition, the present invention is applicable to compact information processing terminals such as a personal digital assistant (PDA), compact music playing device, portable television, portable game machines, and the like.

As set forth hereinabove, according to an embodiment of the present invention, a battery housing of a mobile terminal device includes a cover that closes the opening of the battery housing. The battery housing further includes a first side wall and a second side wall that holds a battery pack from both the sides. On the first side wall is arranged a conductive terminal that contacts a conductive terminal on one side of the battery pack. The second side wall imparts elasticity necessary to press the battery pack towards the first side wall by the contact pressure between another side of the battery pack at the time of housing the battery pack. The second side wall is formed of an elastic material, and includes a side plate which is elastic and bent. Thus, a stable contact can be maintained between the conductive terminal of the mobile telephone and the conductive terminal of the battery pack, which prevents loose connection between these conductive terminals.

Moreover, the battery housing includes, on a predetermined location, a catching slot, and a holding member that is formed on a part of the slot. The catching slot engages with a catching hook of a cover. The holding member abuts with a tip of the second side wall. Therefore, it is possible to reliably fix the second side wall.

When the battery pack is housed in the battery housing, a projection on one side of the battery pack effectively presses the first side wall, which makes it possible to reliably house the battery pack in the battery housing.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal device comprising:
a battery housing that houses therein a battery pack, and includes a first side wall and a second side wall, the first side wall and the second side wall holding the battery pack; and
a cover that covers an opening of the battery housing, wherein
the first side wall includes a conductive terminal that abuts a power supply terminal on a first side of the battery pack housed in the battery housing, and
the second side wall presses the battery pack towards the first side wall by contact pressure between a second side of the battery pack in the battery housing.

2. The mobile terminal device according to claim 1, wherein the second side wall is formed of an elastic material.

3. The mobile terminal device according to claim 1, wherein
the second side wall is elastic, and is bent, and
the second side wall presses the battery pack towards the first side wall with elasticity of the second side wall.

4. The mobile terminal device according to claim 1, wherein the battery housing includes
a slot that engages with a hook of the cover, and is located at a periphery of the opening, and
a holding member that abuts a tip of the second wall, and holds the hook.

5. The mobile terminal device according to claim 1, wherein the battery pack includes a projection on the second side that presses the second wall when the battery pack is being housed in the battery housing.

6. The mobile terminal device according to claim 1, wherein the second side wall is formed of a resin material.
